(19) United States
(12) Patent Application Publication
(10) Pub. No.: US 2006/0120277 A1
(43) Pub. Date: Jun. 8, 2006

(54) Combination dolly and cart

(76) Inventor: Modie Katz, El Dorado, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/290,233

(22) Filed: Nov. 30, 2005

Related U.S. Application Data
(63) Continuation of application No. 10/610,834, filed on Jul. 1, 2003.

(51) Int. Cl. H04J 1/16

(52) U.S. Cl. 370/216; 280/47.131

(57) ABSTRACT

A combination cart is disclosed. The combination cart includes a box for hauling a load. The box includes a bottom portion having four sides, and at least three wall portions attached to the bottom portion and extending perpendicularly outward from the bottom section. An axle is attached to the bottom section and includes wheels mounted on the axle disposed on either side of the box, and a pedal midway between the wheels. A handle with an accessory bar is mounted on the box for maneuvering the combination cart. A gate having an accessory box is mounted on the handle for when the combination cart is used as a dolly and on the box for when the combination cart is used as a cart.

This Application is related to and claims priority to provisional application 60/392,574 filed on Jun. 26, 2002 and is a continuation of U.S. patent Ser. No. 10/610,834 filed on Jun. 23, 2003.

### BACKGROUND OF THE INVENTION

Hand trucks, or dollies, and carts have been utilized by society for many years to haul loads, such as hay, wood, welding tanks, shavings, feed, grain bags, and many other heavy items. A dolly is useful for transporting heavy items in an upright position and makes it easier for one person to do the work of several.

Likewise, a cart is extremely useful to transport loads that may need to be used in several places, and stored temporarily while in transit, such as soil, potted plants, sand, and many others. Since a dolly is not very useful for this type of transportation, a need for a cart arises, and there are various types of carts and dollies.

For example, U.S. Pat. No. 4,099,735 discloses a convertible cart that has a shelf and readily assemblable and disassemblable partition members. The shelf is mounted on a frame and casters are included to provide mobility for the cart. A partition, which may be in the form of bottom and back mats, and side and intermediate panels, are made of rod-like members formed in a grid pattern and include couplings to permit their interconnection and assembly to and from the frame.

Additionally, U.S. Pat. No. 6,105,980 discloses a box for use with a dolly having substantially upright walls. At least one of the walls has at least two surfaces in an offsetting relationship to form an overhang. Also, the dolly has at least one complementary surface for engaging the overhang to support the box.

U.S. Pat. No. 6,019,381 discloses a hand truck with a load carrying nose plate which can be used as a two-wheeled product transporter, as well as a carrier for a fabric receptacle. The frame assembly mounts a nose plate to project generally perpendicularly and a support assembly is connected to the base end of the main frame assembly to provide an extension beyond the nose plate. A generally rigid receptacle suspension frame system allows for the mounting of the fabric receptacle, and has a device for mounting and demounting the outer end of the suspension frame system.

U.S. Pat. No. 6,000,899 discloses a hauler for manipulating a bale of material. The hauler includes a support frame which has a pair of elongated, parallel, members joined at a first end. The hauler also includes a manipulating frame with a pair of parallel members disposed between the support frame. A transverse member connects the pair of manipulating frame members, and a linkage is coupled to the manipulating frame, while an actuator is couple between the support frame and the transverse member to raise or lower the manipulating frame.

Ordinarily, however, to perform the two functions that a dolly and cart would perform, two different pieces of equipment would be required. This adds cost to the consumer and also adds to inefficiency in the operation, in that when a cart is needed, a user must acquire and bring a cart to the worksite, and when a dolly is needed, the user must acquire and bring the dolly.

It would therefore be beneficial to have a single piece of equipment that could be utilized as either a dolly or a cart, so that cost and efficiency could be increased at a worksite by requiring an operator to only have to bring one piece of equipment to the site instead of two. Furthermore, it would be beneficial if the single piece of equipment was capable of being converted from a dolly into a cart and back with ease.

### OBJECTS AND SUMMARY OF THE INVENTION

In accordance with a first object of the present invention, there is provided a novel combination cart and dolly. The combination dolly and cart includes a box for hauling a load. The box includes a bottom portion having four sides, and at least three side portions extending perpendicularly from three sides of the bottom portion. A detachable handle is attached to the box, which also includes a wheel and stabilizing foot. The handle has two positions which are reversible. When placed in a first position, the handle and box function as a dolly. In a second position, they function as a cart.

In accordance with another object of the present invention, there is provided a novel combination cart having a box for hauling a load. The box includes a bottom portion having four sides, and at least three side portions extending perpendicularly from three sides of the bottom portion. A detachable handle is attached to the box, and a gate having an accessory box is attached to the detachable handle. An axle is mounted on the box, including a left wheel and right wheel mounted on the axle on opposing sides of the box, and a pedal is mounted on the axle midway between the left and right wheels. A stabilizing foot is mounted on the box. The axle and wheel should be mounted so that the front edge of the wheel perimeter is flush with the end of the box. This optimizes the balance and the ability of the system to move substantial weights.

In accordance with yet another object of the present invention, there is provided a novel combination cart having a box for hauling a load. The box includes a bottom portion having four sides, and at least three side portions extending perpendicularly from three sides of the bottom portion. A detachable handle is attached to the box, and a gate having an accessory box is attached to the box providing an enclosure for the combination cart. An axle is mounted on the box, including a left wheel and right wheel mounted on the axle on opposing sides of the box, and a pedal is mounted on the axle midway between the left and right wheels. A stabilizing foot is mounted on the box.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a front perspective view of a cart in accordance with a preferred embodiment of the present invention.

FIG. 2 is a rear perspective view of the cart as shown in FIG. 1.

FIG. 3 is a perspective view of a box section of the cart as shown in FIG. 1.

FIG. 4 is a perspective view of a handle section of the cart as shown in FIG. 1.

FIG. 5 is a perspective view of an alternative embodiment of a cart in accordance with the present invention.

### DETAILED DESCRIPTION OF THE PRESENT INVENTION

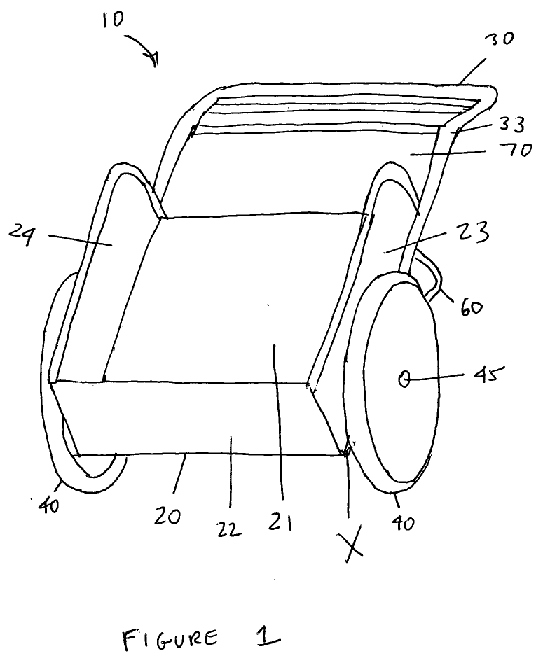

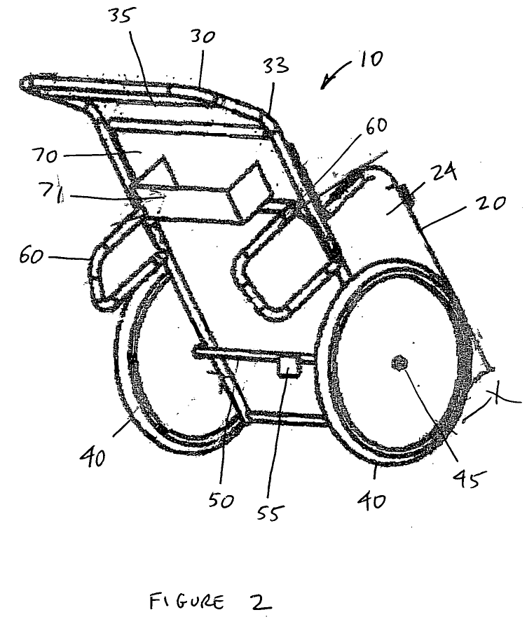

Referring now to the drawings, wherein like reference numerals refer to the same components across the several views, and in particular to FIGS. 1 and 2, there is shown a combination cart 10, which is capable of being converted into either a dolly or a cart. The combination cart 10 includes a box 20, a detachable handle 30, wheels 40, an axle 50, and stabilizing feet 60.

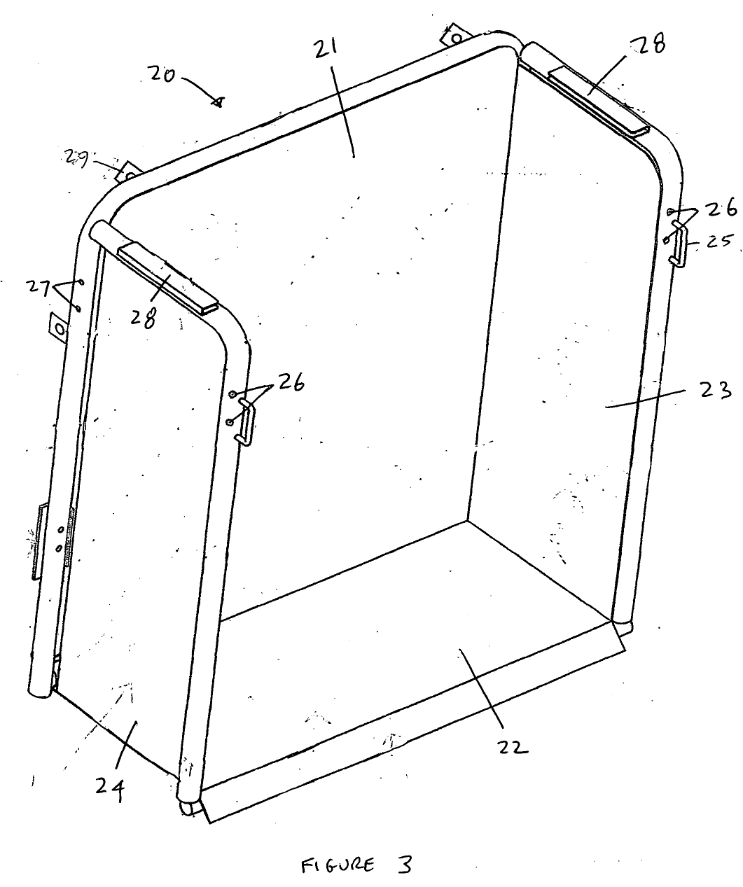

Referring now to FIGS. 1 and 3, the box 20 includes a bottom portion 21, a front wall 22, a left wall 23, and a right wall 24. The bottom portion 21 has four sides, to which the front wall 22, left wall 23, and right wall 24 are attached. The front wall 22 is mounted along one side of the bottom portion 21, and extends perpendicularly outward from the bottom portion 21. The left wall 23 and the right wall 24 are similarly attached to the bottom portion 21 as the front wall 22, but are mounted on opposing sides of the bottom portion 21.

Both the left wall 23 and the right wall 24 include a strap bracket 25 for guiding a strap through in order to keep a load in place within the box 20. Additionally, the left wall 23 and right wall 24 each include cart mounting holes 26 proximate to the strap bracket 25 for mounting the handle 30 when the combination cart 10 is being used as a cart, and not a dolly. Located on the ends of left wall 23 and right wall 24 which are distant to the front wall 22, are gate sliders 28. The gate sliders 28 are for use in the cart configuration, such that the gate 70 may be slid onto the gate sliders 28 to form a fourth wall about the bottom section 21, thus enclosing the entire periphery of the box 20. The bottom portion 21 of box 20 further includes stabilizing feet brackets 29 to mount stabilizing feet 60 upon. Dolly mounting holes 27 are included on the bottom portion 21 for attaching the handle 30 when the combination cart 10 is to be used in the dolly configuration.

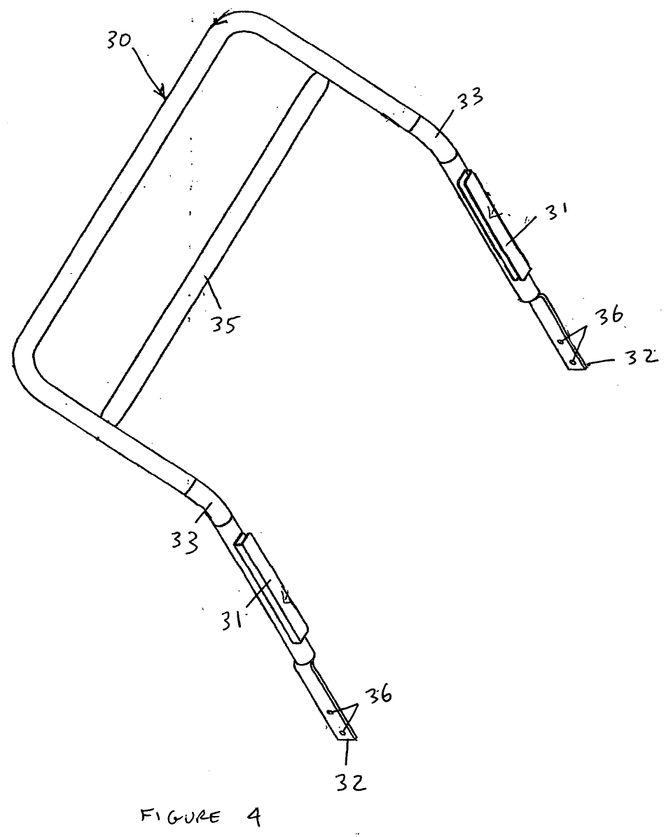

Referring now to FIG. 4, the handle 30 will be described. The handle 30 includes ends 32, which each have attachment holes 36 for attaching the handle 30 to either the dolly mounting holes 27 of bottom portion 21, or to the cart mounting holes 26 which are on the left wall 23 and right wall 24. An elbow 33 is included on handle 30 to facilitate the handling of the combination cart 10 in either the dolly or cart configuration. The handle 30 may be U-shaped for ease of use to an operator when hauling a load in the box 20 of combination cart 10.

As can be seen in FIGS. 1 and 2, in the dolly configuration, the elbows 33 of handle 30 are angled toward the wheels 40 to facilitate operating the combination cart 10 as a dolly. In this configuration, the ends 32 of handle 30 are attached to the dolly mounting holes 27 on the bottom portion 21 of box 20 at the attachment holes 36. The handle 30 may be attached to the bottom portion 21 of box 20 by means of nuts and bolts, or other attachment means known to one of ordinary skill in the art. The handle 30 also includes handle sliders 31. The handle sliders 31 provide an attachment point for the gate 70 when the combination cart 10 is being utilized in the dolly configuration. The gate 70 slides onto the handle sliders 31 much in the same way as it slides onto the gate sliders 28 the left wall 23 and right wall 24 of box 20. In this way, the gate 70 effectively extends the bottom portion 21 of box 20 for added support when transporting a load in the dolly position. Mounted on the gate 70 is an accessory box 71, where an operator may store, for example, tools or other items. An accessory bar 35 is formed into the handle 30 and also operates to provide stability to the handle 30. The wheels are centered.

An axle 50 is attached to the bottom portion 21 of the box 20 to provide a mount for the wheels 40. Wheels 40 are mounted on the axle 50 on opposing sides of box 20, at their respective centers 45. The axle should be mounted such that the edge of the wheel 40 is flush with the front wall 22 shown at Point X. This provides optimal balancing and weight distribution and makes the dolly/cart easy to move with greater weight. Formed approximately centrally along axle 50 is a pedal 55. The pedal 55 serves as a point where an operator of the combination cart 10 in the dolly configuration may place his foot in order to obtain leverage on the combination cart 10 and lift a load located in the box 20. The wheels 40 are formed preferably in a large diameter to ensure an easier time transporting a load in the combination cart 10, however, wheels of varying diameters known to a skilled artisan may be used instead. As noted the position of axles should be such that end of wheels are flush with the front wall 22.

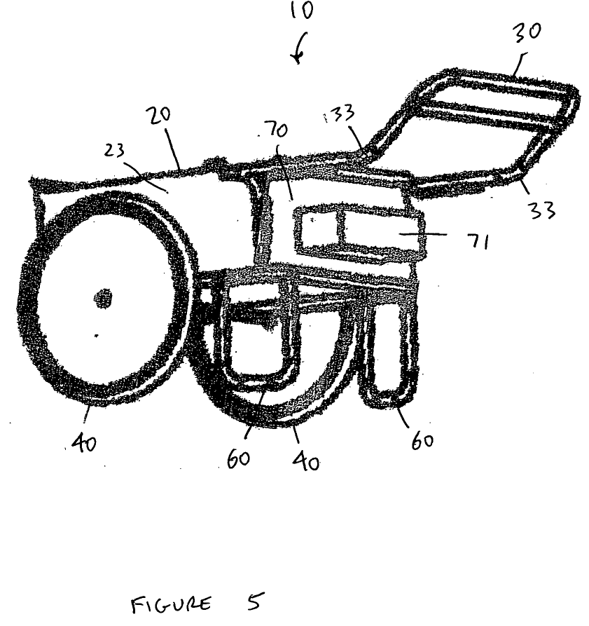

Referring now to FIGS. 3, 4 and 5, the combination cart 10 in the cart position will now be described. In the cart configuration, the handle 30 is mounted by way of attachment holes 36 on the left wall 23 and right wall 24 of the box 20 at the cart mounting holes 26. As shown in FIG. 5, the handle 30 is attached in such a fashion that the elbows 33 are angled upward away from the ground in order to facilitate an operator's ability to lift the combination cart 10 to haul a load. The gate 70 is mounted on the box 20 by sliding it onto the gate sliders 28 on the left wall 23 and right wall 24 of the box 20. In this way, the box 20 becomes an enclosure for carting around a load. Stabilizing feet 60 are attached to the box at the attachment brackets 29. In this manner, the stabilizing feet 60 provide a way to hold a load in box 20 while the combination cart 10 is in a stationary position and there is no operator lifting on the handle 30. The stabilizing feet 60 are “U” shaped in a preferred embodiment of the present invention, however, it can be seen to one of ordinary skill in the art that they may be any shape that will provide sufficient stability to the combination cart 10 when used in the cart configuration.

In view of the foregoing disclosure, some of the advantages of the present invention can be seen. For instance, a combination cart and dolly is disclosed. The combination cart is capable of performing the function of both a cart and a dolly with a simple conversion amounting to mostly nothing more than detaching and reattaching the handle. This provides an opportunity for cost savings by a consumer in that he now has to purchase only one piece of equipment where he had to purchase two beforehand.

While the preferred embodiments of the present invention have been described and illustrated, modifications may be made by one of ordinary skill in the art without departing from the scope and spirit of the invention as defined in the appended claims.

### DOLLY CART REFERENCE NUMBERS

10 Combination cart
20 Box
21 Bottom portion
22 Front ware
23 Left ware
24 Right ware
25 Strap bracket
26 Cart mounting holes
27 Dolly mounting holes
28 Gate sliders
29
30 Handle
31 Handle sliders
32 Ends
33 Elbows
34
35 Accessory bar
36 Attachment holes
37
38
40 Wheels
41
42
43
44
45 Center
46
47
48
49
50 Axle
51
52
53
54
55 Pedal
56
57
58
59
60 Foot (Feet)
61
62
63
64
65
66
67
68
69
70 Gate
71 Tool box

What is claimed is:

1. A combination apparatus which converts from a dolly to a cart comprising:
a box for hauling a load, said box including a bottom portion having four sides, and at least three side portions disposed about at least three sides of the bottom portion and extending perpendicularly outward from the bottom portion;
a detachable handle, said handle removably attached to the box in at least two positions such that handle is used in a first position as a dolly and in a second position as a cart;
at least one wheel, attached to said box; and
at least one stabilizing foot attached to the box.

2. The apparatus of claim 1, further comprising a gate portion, removably attached to the fourth side of said box and extending outward.

3. The apparatus of claim 2, wherein the gate portion further comprises an accessory box mounted on said gate portion.

4. The apparatus of claim 1, further comprising a gate portion removably attached to the detachable handle, extending away from the bottom portion of the box.

5. The apparatus of claim 4, wherein the gate portion further comprises an accessory box mounted on said gate portion.

6. The apparatus of claim 1, further comprising an axle mounted on the underside of the box for mounting the at least one wheel.

7. The apparatus of claim 6, wherein the at least one wheel comprises two wheels mounted on the axle, said two wheels mounted on opposing sides of said box.

8. The apparatus of claim 1 wherein the axle is located at a distance such that outer perimeter of each wheel is flush with the front side of the box.

9. The apparatus of claim 7, further comprising a pedal mounted on said axle midway between the two wheels.

10. The apparatus of claim 1, wherein the at least one stabilizing foot is U-shaped.

11. The apparatus of claim 10, wherein the at least one U-shaped stabilizing foot comprises two U-shaped stabilizing feet mounted on opposing sides of the box.

12. The apparatus of claim 1, wherein the detachable handle is U-shaped, having a handle portion and opposing parallel shafts.

13. The apparatus of claim 11, wherein the detachable U-shaped handle further comprises an accessory bar formed into the handle transversing the opposing parallel shafts.

14. A combination dolly and cart, comprising:
a box for hauling a load, said box including a bottom portion having four sides, and at least three side portions disposed about at least three sides of the bottom portion and extending perpendicularly outward from the bottom portion;
a detachable handle, said handle removably attached to the box and that the handle when placed in a first position is a dolly and is a cart when placed into second position;
at least one stabilizing foot attached to the box;
a gate attached to the detachable handle, said gate including an accessory box;
an axle mounted on the box;
a left wheel and a right wheel attached to said axle and mounted on opposing sides of said box; and
a pedal mounted on said axle midway between said left wheel and right wheel.

15. A dolly combination cart, comprising:
a box for hauling a load, said box including a bottom portion having four sides, and at least three side portions disposed about at least three sides of the bottom portion and extending perpendicularly outward from the bottom portion;
a detachable handle, said handle removably attached to the box;
at least one stabilizing foot attached to the box;
a gate attached to the box, said gate including an accessory box;
an axle mounted on the box;
a left wheel and a right wheel attached to said axle and mounted on opposing sides of said box; and
a pedal mounted on said axle midway between said left wheel and right wheel.
